(19) United States
(12) Patent Application Publication
(10) Pub. No.: US 2025/0038455 A1
(43) Pub. Date: Jan. 30, 2025

(54) LEVER-TYPE CONNECTOR

(71) Applicant: SUMITOMO WIRING SYSTEMS, LTD., Mie (JP)

(72) Inventors: Toshihiro ITO, Mie (JP); Tsuyoshi MASE, Mie (JP); Takahiro KIKUCHI, Mie (JP); Yoichi TAKAGI, Mie (JP); Sho KOBAYASHI, Mie (JP); Toya TAICHI, Mie (JP)

(21) Appl. No.: 18/765,810

(22) Filed: Jul. 8, 2024

(30) Foreign Application Priority Data
Jul. 24, 2023 (JP) 2023-119852

(51) Int. Cl. H01R 13/629

(52) U.S. Cl. CPC H01R 13/6295

(57) ABSTRACT

A lever-type connector includes a housing, a lever to be mounted on the housing rotatably between an initial position and a completion position, and a detecting member to be mounted into the housing movably between a standby position and a detection position. The detecting member is movable from the standby position to the detection position with the lever located at the completion position. The lever includes a pair of plate-like portions, an operating portion coupling the pair of plate-like portions in a first direction and a projecting portion projecting from the operating portion. The detecting member includes a body portion and a recess recessed from the body portion. The detecting member is disposed inside the pair of plate-like portions in the first direction and the projecting portion is disposed in the recess with the lever located at the initial position and the detecting member located at the standby position.

### CROSS-REFERENCE TO RELATED APPLICATIONS

This application is based on and claims priority from Japanese Patent Application No. 2023-119852, filed on Jul. 24, 2023, with the Japan Patent Office, the disclosure of which is incorporated herein in its entirety by reference.

### TECHNICAL FIELD

The present disclosure relates to a lever-type connector.

### BACKGROUND

A lever connection-type connector described in Japanese Patent Laid-open Publication No. 2005-294038 is conventionally known as a lever-type connector provided with a connection detecting member. The lever connection-type connector described in Japanese Patent Laid-open Publication No. 2005-294038 is provided with a male connector including a connection lever, a female connector to be connected to the male connector and a connection detecting member to be mounted into the male connector. In a state before the male and female connectors are connected, the connection detecting member is temporarily locked to the male connector at a position before a proper lock position. If the connection lever is rotated and the male and female connectors are connected, a temporary lock releasing projection of the connection lever pushes down a temporary locking portion of the connection detecting member. In this way, the connection detecting member is pushed to the proper lock position and the connection completion of the male and female connectors can be detected.

### SUMMARY

In the above configuration, the connection detecting member is exposed to outside in a state where the connection detecting member is temporarily locked to the male connector before the connection of the male and female connectors. Therefore, there is a possibility that the connection detecting member is damaged by an external force or the like. Further, the connection detecting member may be possibly forcibly pushed to the proper lock position or detached from the male connector.

Further, a space is present between a grip portion of the connection lever and a housing of the male connector before the connection of the male and female connectors. Therefore, there is a possibility that both leg portions of the connection lever are deformed to enter this space, such as during a connection operation of the male and female connectors.

Accordingly, it is an object of the present invention to improve operability of a lever-type connector.

This object is solved according to the invention by the features of the independent claims. Particular embodiments of the invention are subject of the dependent claims.

The present disclosure is directed to a lever-type connector with a housing, a lever to be mounted on the housing displaceably (particularly rotatably or pivotably) between an initial position and a completion position and a detecting member to be mounted into the housing movably between a standby position and a detection position, the detecting member being movable from the standby position to the detection position with the lever located at the completion position, the lever including a pair of plate-like portions, an operating portion coupling the pair of plate-like portions in a first direction and a projecting portion projecting from the operating portion, the detecting member including a body portion and at least one recess recessed from the body portion, and the detecting member at least partly being disposed inside the pair of plate-like portions in the first direction and the projecting portion at least partly being disposed in the recess with the lever located at the initial position and the detecting member located at the standby position.

Particularly, the lever-type connector is provided with a housing, a lever to be mounted on the housing rotatably between an initial position and a completion position and a detecting member to be mounted into the housing movably between a standby position and a detection position, the detecting member being movable from the standby position to the detection position with the lever located at the completion position, the lever including a pair of plate-like portions, an operating portion coupling the pair of plate-like portions in a first direction and a projecting portion projecting from the operating portion, the detecting member including a body portion and a recess recessed from the body portion, and the detecting member being disposed inside the pair of plate-like portions in the first direction and the projecting portion being disposed in the recess with the lever located at the initial position and the detecting member located at the standby position.

Accordingly, since the detecting member is disposed inside the lever with the lever located at the initial position and the detecting member located at the standby position, it is possible to suppress the damage of the detecting member by an external force or the like, a movement of the detecting member to the detection position, the detachment of the detecting member from the housing and the like. Further, since the projecting portion of the lever is disposed in the recess of the detecting member, the lever is easily positioned in the first direction by the detecting member. Therefore, a deviation of the lever in the first direction can be suppressed and the deformation and breakage of the lever can be suppressed.

Further particularly, the detecting member at least partly is disposed inside the pair of plate-like portions in the first direction and the projecting portion at least partly is disposed in the recess until the lever is displaced (particularly rotated or pivoted) by a predetermined distance (particularly angle) from the initial position toward the completion position.

Accordingly, the detecting member and the lever can be protected while the lever is displaced (particularly rotated) by the predetermined angle from the initial position. Further, the projecting portion and the recess are caused to slide in contact, whereby a displacement operation (particularly rotation operation) of the lever can be guided.

Further particularly, the detecting member includes one or more protruding portions projecting in the first direction from the body portion, preferably toward both sides in the first direction, from the body portion, and the one or more protruding portions contact the one or more plate-like portions, thereby restricting movements of the plate-like portions in directions toward the housing along the first direction.

Accordingly, the deformation of the lever in the first direction can be further suppressed. Further, the displacement operation (particularly rotation operation) of the lever can be guided.

Further particularly, the housing includes at least one deflectable and deformable lock arm extending from an outer surface of the housing, and the projecting portion includes at least one slide-contact portion for deflecting the lock arm by sliding in contact with the lock arm in the process of displacing (particularly rotating or pivoting) the lever from the initial position toward the completion position.

Further particularly, the lock arm slides in contact with the slide-contact portion, whereby the lock arm is locked to the detecting member and a movement of the detecting member from the standby position to the detection position is restricted.

Accordingly, since a movement of the detecting member to the detection position is restricted during the displacement (rotation) operation of the lever by the slide-contact portion, erroneous detection of the connection completion is suppressed by the detecting member.

Further, since the projecting portion particularly includes the slide-contact portion, a slide-contact portion may not be provided at a position different from the projecting portion in the lever. Thus, the lever and the lever-type connector are easily reduced in size.

Further particularly, the projecting portion includes at least one lock portion to be locked to the housing with the lever located at the completion position.

According to this configuration, since the projecting portion includes the lock portion, a lock portion may not be provided at a position different from the projecting portion in the lever. Thus, the lever and the lever-type connector are easily reduced in size.

According to the above, it is possible to provide a lever-type connector capable of protecting a detecting member and a lever.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a lever-type connector according to an embodiment with a lever disposed at an initial position.

FIG. 2 is a perspective view of the lever.

FIG. 3 is a perspective view of a detecting member.

FIG. 4 is a side view of the lever-type connector with the lever disposed at the initial position.

FIG. 5 is a plan view of the lever-type connector with the lever disposed at the initial position.

FIG. 6 is a section along A-A of FIG. 5.

FIG. 7 is a section along B-B of FIG. 5.

FIG. 8 is a section along C-C of FIG. 5.

FIG. 9 is a section along D-D of FIG. 5.

FIG. 10 is a section along E-E of FIG. 5.

FIG. 11 is a perspective view of the lever-type connector showing a state where the lever is disposed at a completion position and the detecting member is disposed at a standby position.

FIG. 12 is a side view of the lever-type connector showing the state where the lever is disposed at the completion position and the detecting member is disposed at the standby position.

FIG. 13 is a section along A-A of FIG. 5 showing a state where the lever-type connector and a mating connector are connected and the detecting member is disposed at the standby position.

FIG. 14 is a section along B-B of FIG. 5 showing the state where the lever is disposed at the completion position and the detecting member is disposed at the standby position.

FIG. 15 is a side view of the lever-type connector showing a state where the lever is disposed at the completion position and the detecting member is disposed at a detection position.

FIG. 16 is a section along A-A of FIG. 5 showing a state where the lever-type connector and the mating connector are connected and the detecting member is disposed at the detection position.

FIG. 17 is a side view of the lever-type connector showing a state where the lever is disposed at a first position and the detecting member is disposed at the standby position.

FIG. 18 is a section along C-C of FIG. 5 showing the state where the lever is disposed at the first position and the detecting member is disposed at the standby position.

FIG. 19 is a section along B-B of FIG. 5 showing the state where the lever is disposed at the first position and the detecting member is disposed at the standby position.

FIG. 20 is a section along D-D of FIG. 5 showing the state where the lever is disposed at the first position and the detecting member is disposed at the standby position.

FIG. 21 is a section along E-E of FIG. 5 showing the state where the lever is disposed at the first position and the detecting member is disposed at the standby position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

Hereinafter, an embodiment of the present disclosure is described. The present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different in each figure. “Orthogonal” in this specification means not only strictly orthogonal, but also substantially orthogonal within a range in which functions and effects in the embodiment are achieved.

Further, “facing each other” in this specification indicates that surfaces or members are at positions in front of each other, and means not only a case where the surfaces or members are at positions perfectly in front of each other, but also a case where the surfaces or members are at positions partially or substantially in front of each other. Further, “facing each other” in this specification means both a case where another member different from two parts at least partly is interposed between the two parts and a case where nothing is interposed between the two parts.

### Embodiment

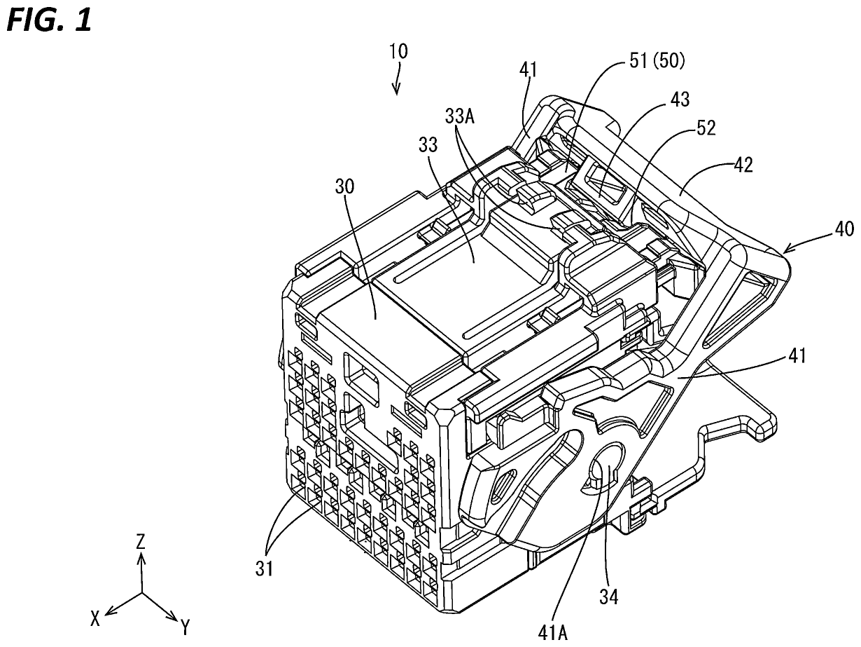

The particular embodiment of the present disclosure is described with reference to FIGS. 1 to 21. In the following description, a direction indicated by an arrow Z is referred to as an upward direction, a direction indicated by an arrow X is referred to as a forward direction and a direction indicated by an arrow Y is referred to as a leftward direction. A lateral direction is an example of a first direction. Note that, for a plurality of identical members, only some members may be denoted by a reference sign and the others may not be denoted by the reference sign.

### (Lever-Type Connector 10)

As shown in FIG. 1, a lever-type connector 10 is provided with a housing 30, a lever 40 and/or a detecting member 50.

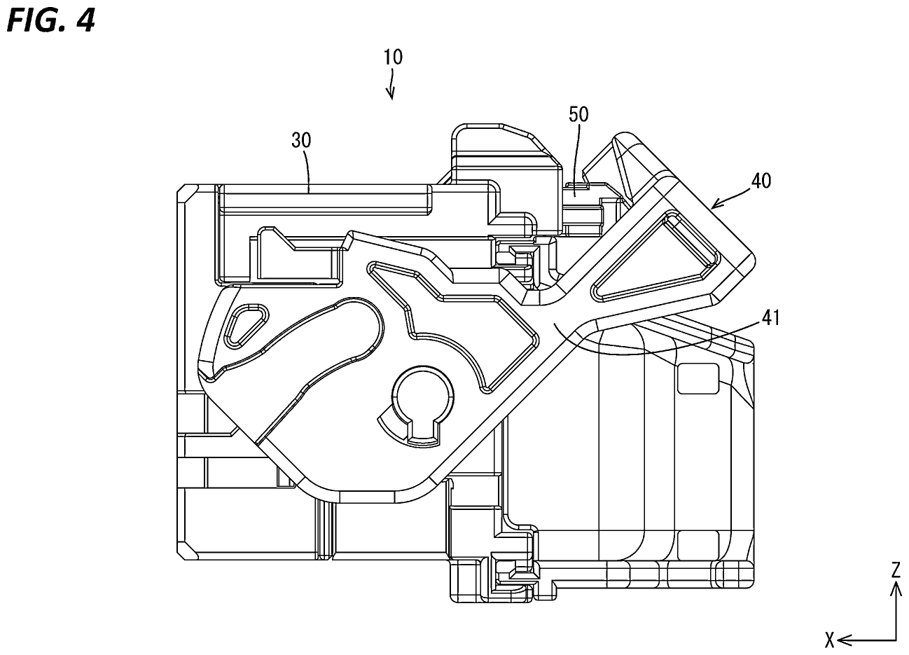

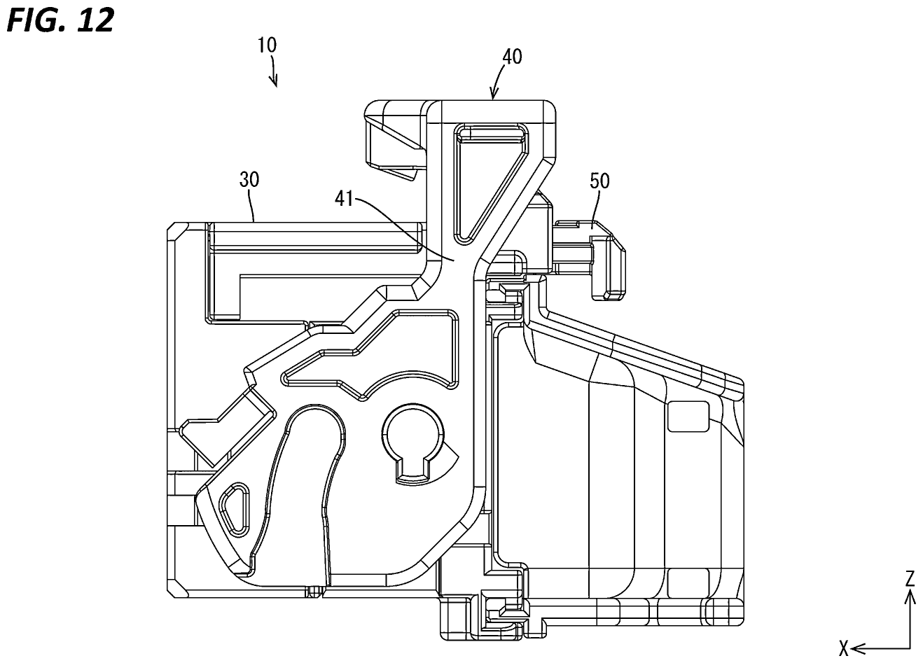

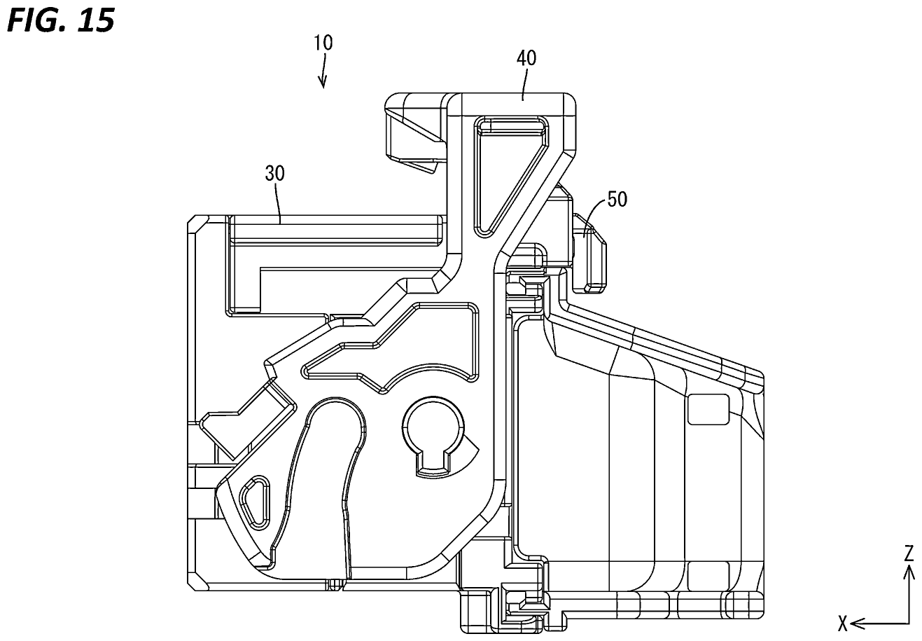

The lever 40 is mounted or mountable on or to the housing 30 displaceably (particularly rotatably or pivotably) between an initial position shown in FIG. 4 and a completion position shown in FIGS. 12 and 15.

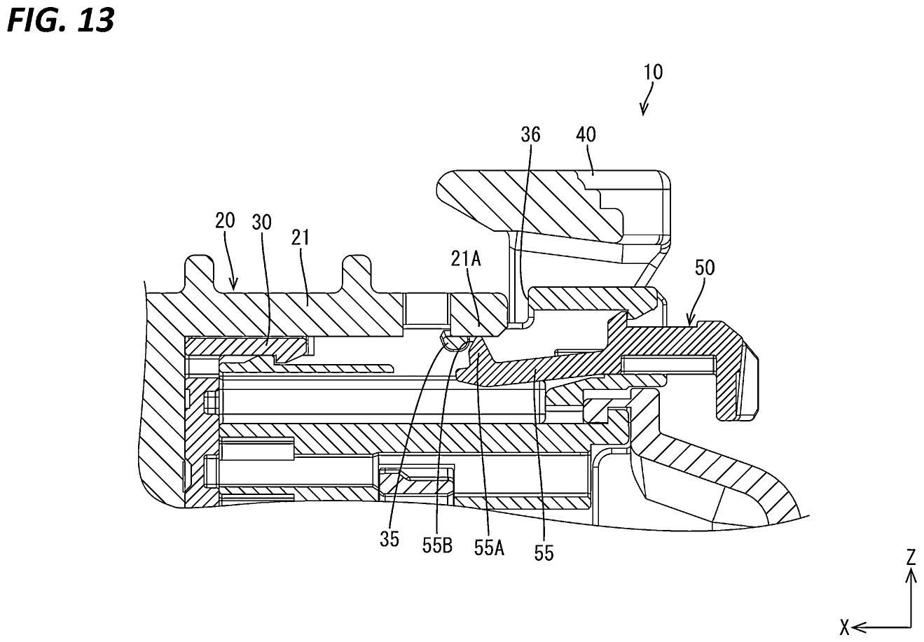

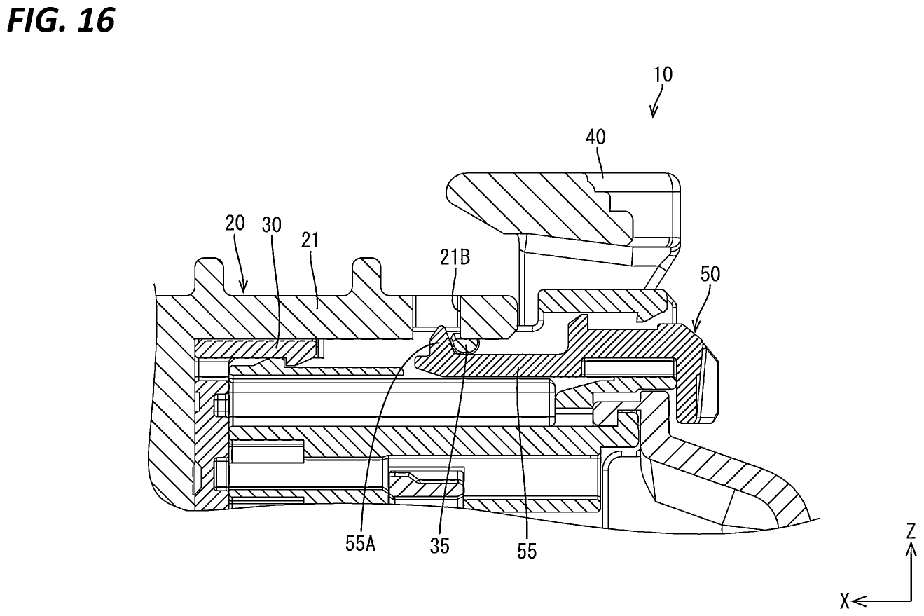

As shown in FIGS. 13 and 16, the lever-type connector 10 is to be connected to a mating connector 20. The mating connector 20 is provided with a receptacle 21 capable of at least partly accommodating the housing 30 and one or more mating terminals (not shown) to be held in the receptacle 21.

The receptacle 21 includes one or more cam pins (not shown) projecting from a lateral inner surface of the receptable, particularly from left and right inner surfaces of the receptacle 21.

In starting the connection of the lever-type connector 10 and the mating connector 20, the lever-type connector 10 and the mating connector 20 are lightly connected with the lever 40 arranged at or near the initial position.

Then, the one or more cam pins at least partly enter one or more respective cam grooves 41B provided in the lever 40 and at least partly engaged with the inner walls of the cam grooves 41B.

By displacing (particularly rotating or pivoting) the lever 40 towards or to the completion position with the cam pin(s) and the inner wall(s) of the cam groove(s) 41B substantially engaged, the connection of the lever-type connector 10 and the mating connector 20 is assisted or completed, particularly by a cam action displayed between the cam pin(s) and the cam groove(s).

If the lever 40 is displaced (particularly rotated or pivoted) from the completion position towards or to the initial position, the lever-type connector 10 is separated from the mating connector 20.

### (Housing 30)

The housing 30 particularly is made of insulating synthetic resin.

As shown in FIG. 1, the housing 30 particularly has a substantially rectangular parallelepiped shape.

Specifically, the housing 30 is provided with one or more terminal accommodating portions 31 for at least partly accommodating one or more unillustrated terminals. The terminal accommodating portion 31 particularly is formed to penetrate through the housing 30 substantially in a front-rear direction.

The terminal is made of electrically conductive material such as metal and is to be connected to the mating terminal.

An unillustrated wire is to be connected to the terminal, and drawn out from a draw out surface, particularly substantially rearward from the housing 30.

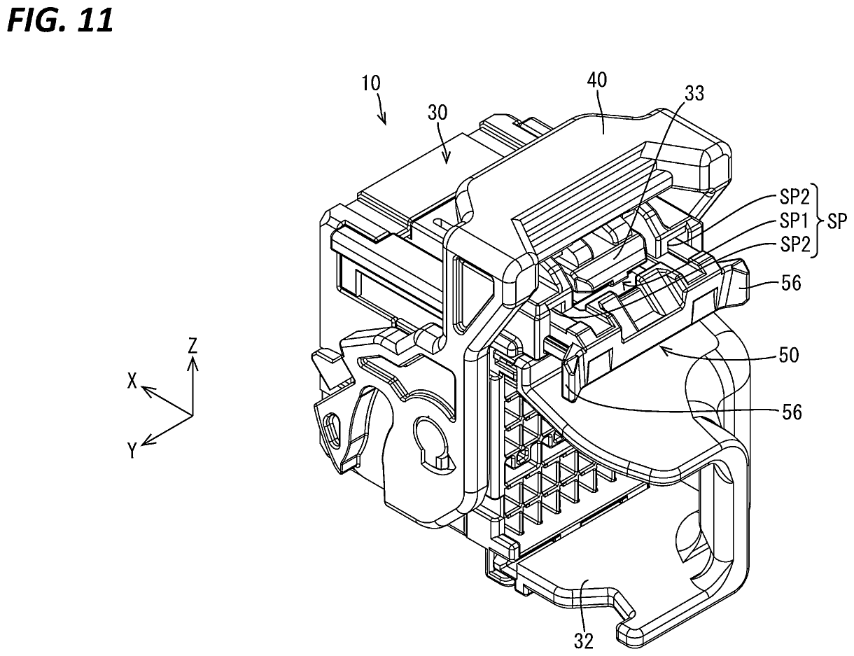

As shown in FIG. 11, a wire cover 32 for at least partly covering the wires particularly is mounted or mountable on the draw out surface, particularly on a rear end part of the housing 30.

As shown in FIG. 1, at least one lock arm 33 particularly is formed on (particularly the upper surface of) the housing 30. The lock arm 33 substantially extends rearward on the housing 30, particularly substantially from a front part of the upper surface of the housing 30.

The lock arm 33 is resiliently deformable towards and away from the housing 30, e.g. substantially in a vertical direction.

The lock arm 33 particularly includes one or more connection lock portions 33A projecting outward (e.g. upward) from the outer or upper surface of the lock arm 33.

The one or more connection lock portions 33A are locked or lockable to the lever 40. The upper surfaces of the connection lock portions 33A particularly substantially are curved surfaces convex outward or upward.

Specifically, the housing 30 includes one or more (particularly rotary) shafts 34 substantially projecting outward in the lateral direction from respective side surface(s) of the housing 30. The rotary shaft 34 particularly has a substantially cylindrical shape.

By at least partly inserting the one or more (particularly rotary) shafts 34 into one or more shaft holes 41C provided in the lever 40, the lever 40 is assembled with the housing 30.

As shown in FIG. 11, the housing 30 particularly includes an accommodation space SP capable of at least partly accommodating the detecting member 50.

Specifically, the accommodation space SP includes a first accommodation space SP1 and one or more, particularly a pair of second accommodation spaces SP2. The one or more second accommodation spaces SP2 communicate with the first accommodation space SP1 and are provided laterally (particularly on both sides) of the first accommodation space SP1.

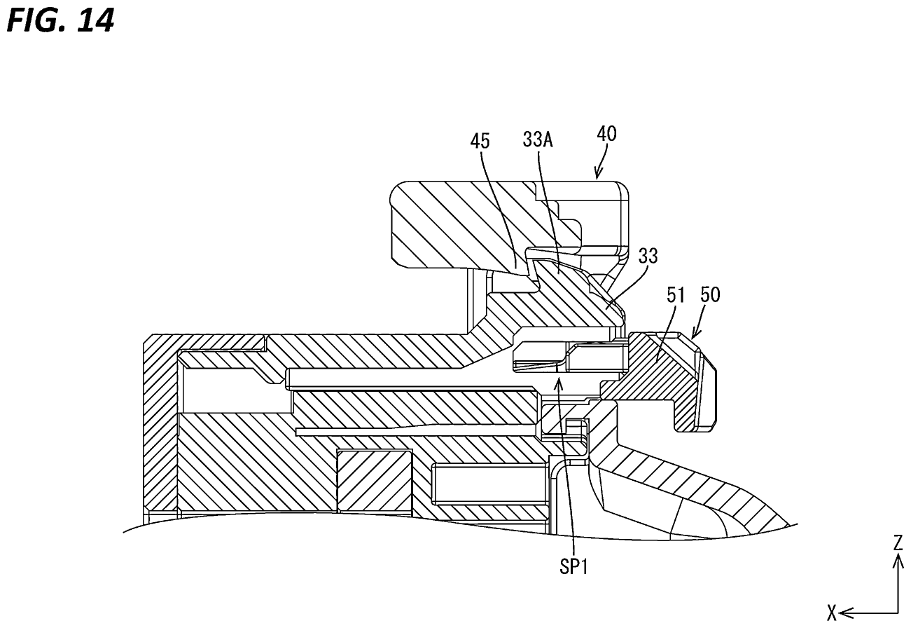

The first accommodation space SP1 particularly is provided substantially below (or inside of) the lock arm 33 (see FIG. 14).

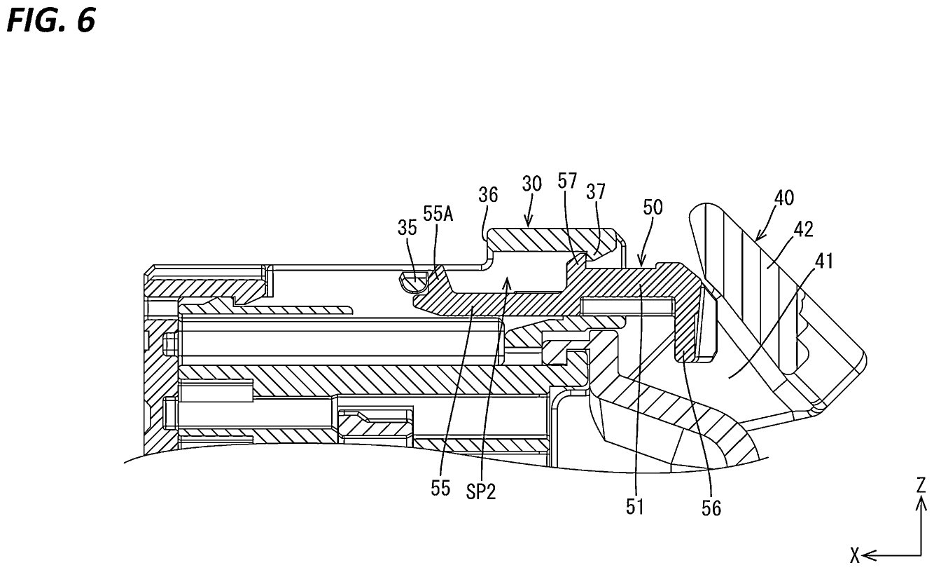

As shown in FIG. 6, the housing 30 particularly includes one or more first locking portions 35 disposed at positions near front end parts of the second accommodation spaces SP2.

The first locking portion 35 particularly substantially extends in the lateral direction and is connected to an inner wall constituting the second accommodation space SP2.

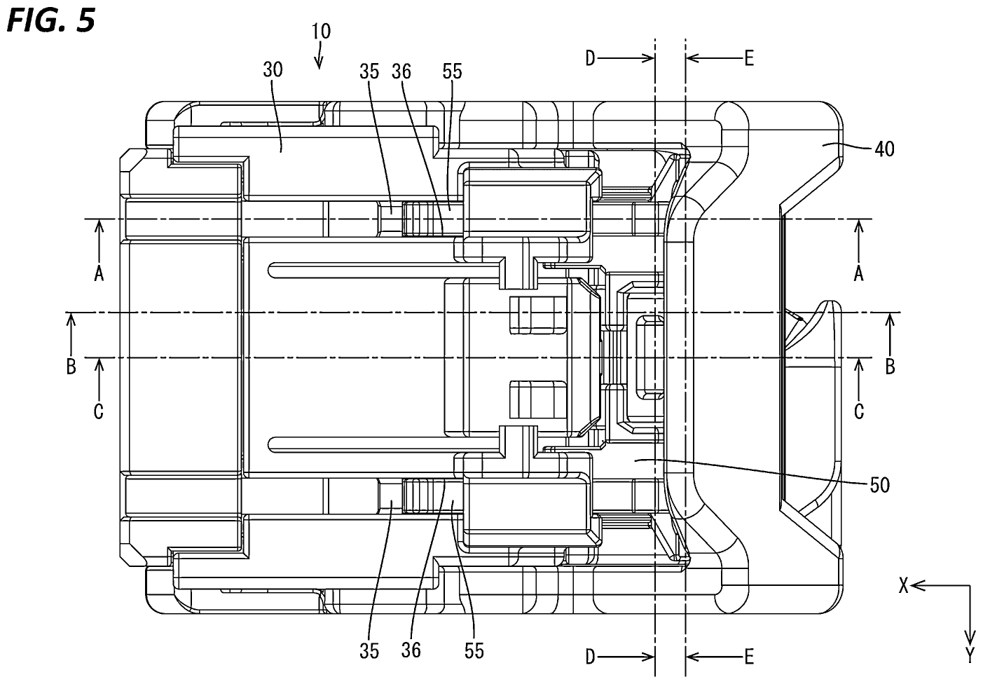

The housing 30 particularly includes one or more openings 36 behind the first locking portion(s) 35. The openings 36 substantially communicate with the second accommodation spaces SP2. Alternatively or additionally, the one or more openings 36 are open in the vertical direction and/or communicate with an outside space (see FIG. 5). As shown in FIG. 6, the housing 30 particularly includes one or more temporary locking projections 37 to be disposed in rear portions or halves of the second accommodation space(s) SP2.

The temporary locking projection 37 particularly projects substantially inwardly or downward from a separation wall defining the accommodation space SP2 from outside or above.

### (Lever 40)

The lever 40 is made of insulating synthetic resin.

As shown in FIG. 5, the lever 40 particularly is substantially U-shaped as a whole.

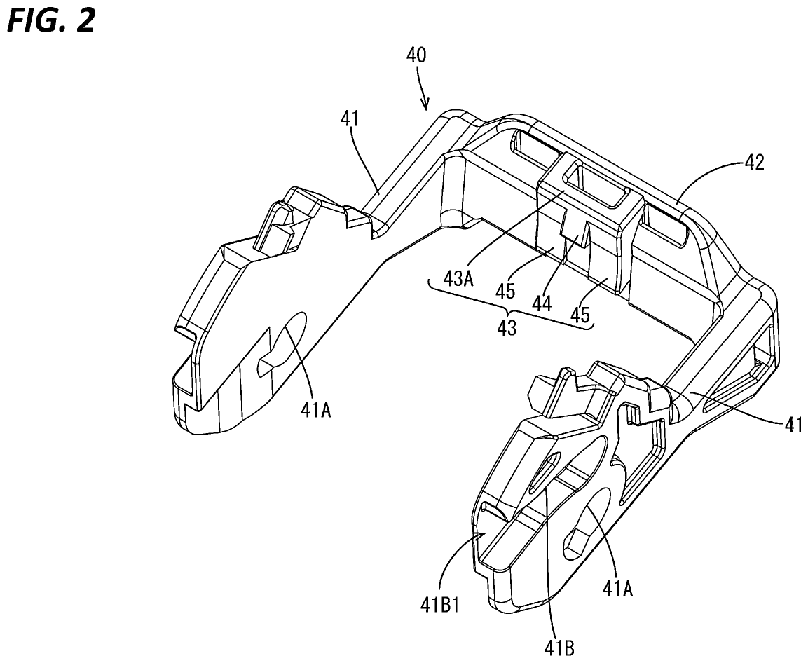

Specifically, as shown in FIG. 2, the lever 40 includes a pair of plate-like portions 41, an operating portion 42 connecting (particularly end parts of) the pair of plate-like portions 41 and/or a projecting portion 43 projecting from the operating portion 42.

The two plate-like portions 41 particularly are disposed to face each other.

The plate-like portion 41 particularly is formed with a shaft hole 41A penetrating into or through the plate-like portion 41 and/or the cam groove 41B recessed in a thickness direction (lateral direction) of the plate-like portion 41 from the outer surface of the plate-like portion 41.

The cam groove 41B particularly includes an entrance opening 41B1 in an outer edge part of the plate-like portion 41, and/or extends in a substantially arcuate manner from the entrance opening 41B1 to approach the shaft hole 41A.

The entrance opening 41B1 particularly serves as an opening for at least partly receiving the cam pin into the cam groove 41B.

### (Projecting Portion 43)

The projecting portion 43 projects inward (particularly substantially in a rotation radial direction) from the operating portion 42.

Here, the rotation radial direction particularly substantially is an extension direction of an axis orthogonal to an extension direction (lateral direction) of the rotary shafts 34 and passing through a center of rotation, a direction toward the rotary shafts 34 is an inward direction, and a direction away from the rotary shafts 34 is an outward direction.

The projecting portion 43 particularly includes a (particularly substantially block-like) base portion 43A and/or a pressing portion 44 and/or one or more lock portions 45 substantially projecting inward along the rotation radial direction from the base portion 43A.

The pressing portion 44 particularly substantially is disposed at a lateral center position of (particularly a front half of) the base portion 43A.

The one or more lock portions 45 particularly are disposed laterally of the base portion 43A, particularly on both left and right end parts of a rear half of the base portion 43A. The base portion 43A, the pressing portion 44 and/or the lock portions 45 are an example of a slide-contact portion.

### (Detecting Member 50, Recess 52)

The detecting member 50 is made of insulating synthetic resin.

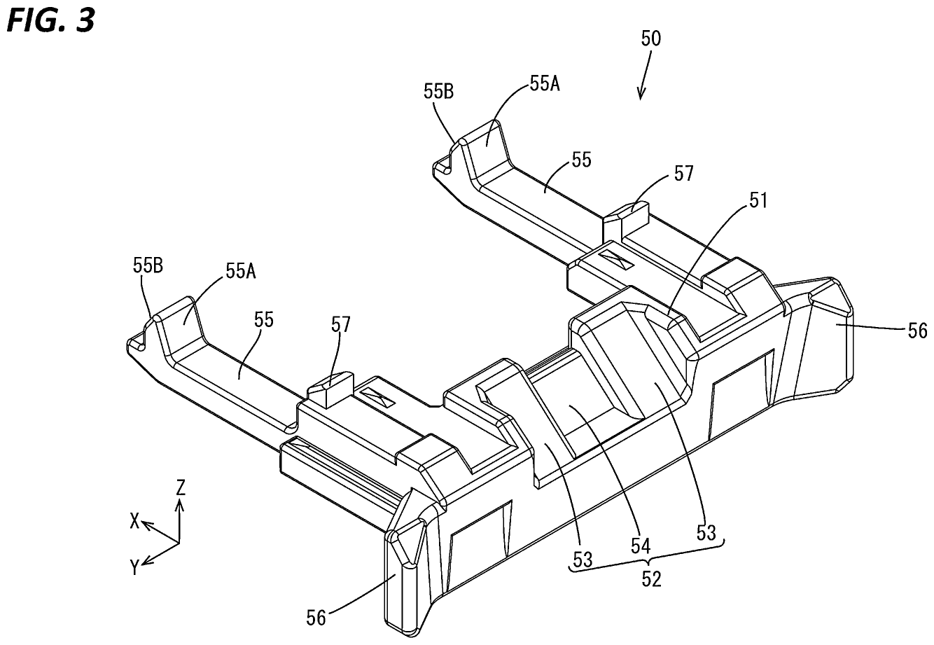

Specifically, as shown in FIG. 3, the detecting member 50 includes a body portion 51 and a recess 52 recessed from the body portion 51.

The body portion 51 particularly has a substantially gate shape in which both end parts in a width direction (lateral direction) extend forward.

The recess 52 particularly substantially is disposed in a lateral central part of the body portion 51.

The recess 52 particularly includes one or more first recesses 53 and/or at least one second recess 54 recessed further from the bottom surface(s) of the first recess(es) 53.

The second recess 54 particularly substantially is disposed in a lateral central part of the recess 52.

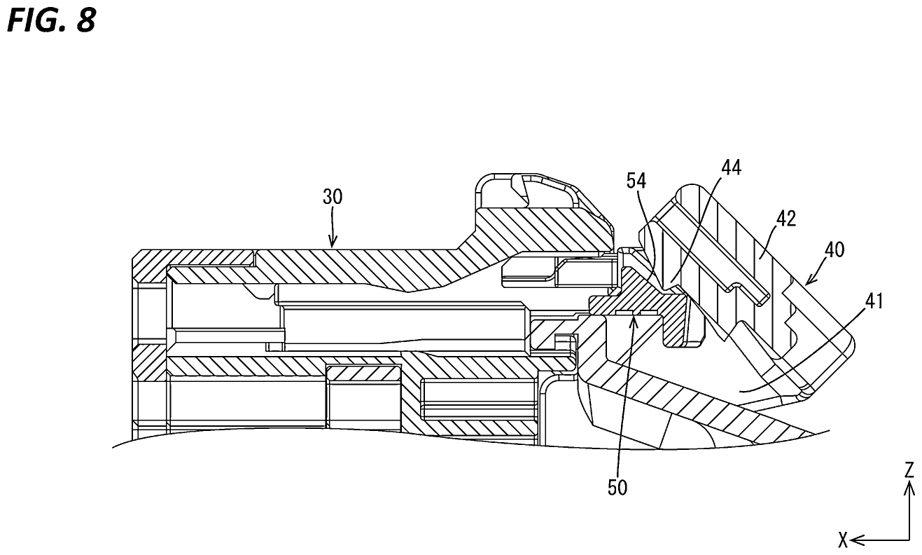

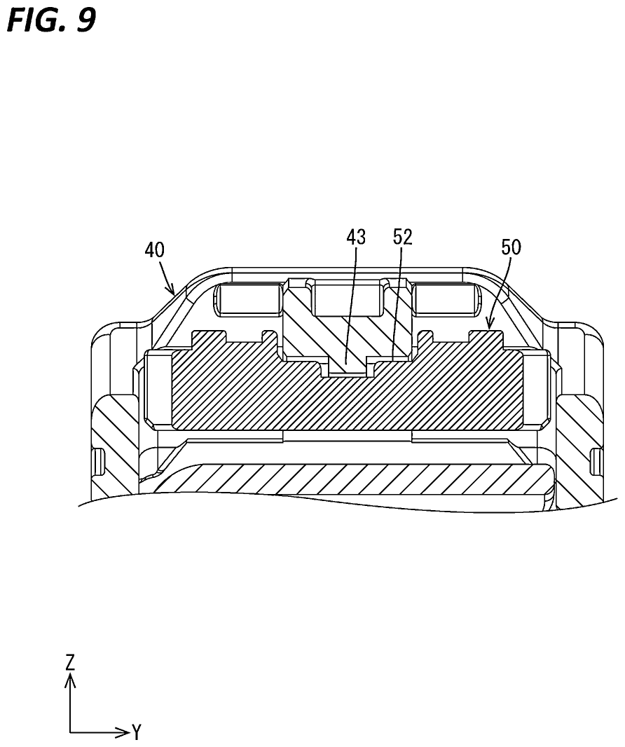

Specifically, as shown in FIGS. 1 and 9, the projecting portion 43 of the lever 40 can at least partly enter the recess 52 (to be described in detail later). As shown in FIG. 8, the pressing portion 44 of the lever 40 particularly can at least partly enter the second recess 54.

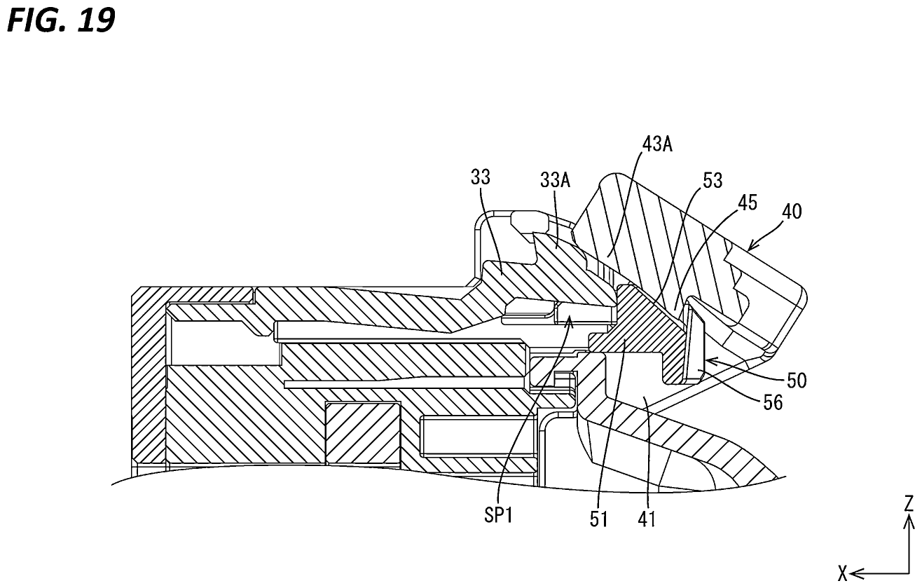

As shown in FIG. 19, the lock portion(s) 45 of the lever 40 particularly can at least partly enter the first recesses 53.

As shown in FIG. 3, the detecting member 50 particularly is provided with one or more arm portions 55 respectively extending forward from a lateral part of the body portion 51, particularly from right and left end parts of the body portion 51.

The arm portion 55 particularly is deflectable and deformable substantially in the vertical direction with a rear end part connected to the body portion 51 as a base end.

A locking projection 55A particularly is formed on the arm portion 55, particularly at a position near a front end part of the arm portion 55.

The locking projection 55A particularly projects upward from the arm portion 55. Specifically, an inclined portion 55B is formed on an upper part of a front side of the locking projection 55A. The inclined portion 55B particularly substantially is inclined downward toward the front (see FIG. 13).

As shown in FIG. 6, the locking projection 55A particularly is lockable to the first locking portion 35.

### (Protruding Portions 56)

As shown in FIG. 3, one or more protruding portions 56 projecting from (particularly both side surfaces of) the body portion 51 are formed on the rear end part of the body portion 51 of the detecting member 50.

The protruding portion 56 particularly substantially extends in a direction separating from the side surface of the body portion 51 along the lateral direction and/or also extends rearward.

The detecting member 50 can be operated, for example, by pinching the one or more protruding portions 56 with a thumb and an index finger (see FIG. 11).

The detecting member 50 can be moved between a standby position (see FIG. 6) and a detection position (see FIG. 16). In the embodiment, the detection position is disposed forward of the standby position and/or the detecting member 50 substantially is movable in the front-rear direction.

As shown in FIG. 3, the detecting member 50 particularly includes one or more temporary locking portions 57 projecting from the upper or outer surface of the body portion 51.

Specifically, the temporary locking portions 57 are provided on right and left sides of the upper surface of the body portion 51.

As shown in FIG. 6, the one or more temporary locking portions 57 particularly are disposed to be lockable to the one or more temporary locking projections 37 with the detecting member 50 located at the standby position.

A rearward movement of the detecting member 50 from the standby position particularly is suppressed by locking the temporary locking portion(s) 57 and the temporary locking projection(s) 37.

To mount the detecting member 50 into the housing 30, the one or more arm portions 55 and/or one or more side parts of the body portion 51 of the detecting member 50 particularly are first at least partly inserted into the second accommodation spaces SP2.

The one or more arm portions 55 particularly at least partly are disposed in the second accommodation spaces SP2 and/or front end part(s) of the temporary locking portion(s) 57 and/or rear end part(s) of the temporary locking projection(s) 37 particularly slide in contact.

If the detecting member 50 is pushed further forward, the one or more temporary locking projections 37 ride over the one or more temporary locking portions 57. In this way, the detecting member 50 is disposed at the standby position.

With the detecting member 50 located at the standby position, a forward movement of the detecting member 50 particularly is restricted by locking the locking projection(s) 55A and the first locking portion(s) 35.

Further, a rearward movement of the detecting member 50 particularly is restricted by locking the rear end surface(s) of the temporary locking portion(s) 57 and the front end surface(s) of the temporary locking projection(s) 37.

Specifically, after the detecting member 50 is mounted into the housing 30, the lever 40 is mounted on the (particularly rotary) shafts 34 of the housing 30. The lever 40 particularly is assembled with the housing 30 from above while the pair of plate-like portions 41 are deformed away from each other.

As shown in FIGS. 4 to 6 and 8, a part (particularly, a rear end part) of the detecting member 50 particularly is disposed between the plate-like portions 41 with the lever 40 located at the initial position and/or the detecting member 50 located at the standby position.

Further, as shown in FIGS. 6 to 8, the operating portion 42 particularly is arranged behind the detecting member 50. In this way, the detecting member 50 is protected from outside by the lever 40.

Therefore, it is possible to suppress the damage of the detecting member 50 by an external force or the like, a movement of the detecting member 50 to the detection position, the detachment of the detecting member 50 from the housing 30 and the like. Thus, operability of the lever-type connector is improved.

As shown in FIGS. 1 and 9, the projecting portion 43 particularly least partly is disposed in the recess 52 with the lever 40 located at the initial position and/or the detecting member 50 located at the standby position.

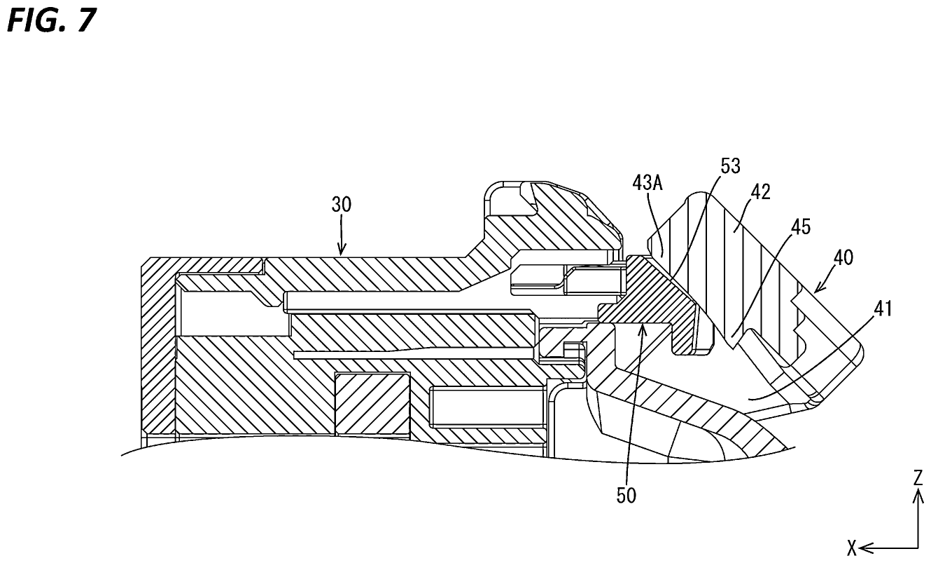

In particular, the base portion 43A is disposed in the first recess(es) 53 (see FIG. 7) and/or the pressing portion 44 particularly is disposed in the second recess 54 (see FIG. 8).

As shown in FIG. 9, the inner surface of the recess 52 and the outer surface of the projecting portion 43 particularly substantially are facing and proximate to each other in the lateral direction.

Thus, the lever 40 is or can be easily positioned in the lateral direction by the detecting member 50. A deviation of the lever 40 in the lateral direction particularly can be suppressed and/or the deformation and breakage of the lever 40 particularly can be suppressed.

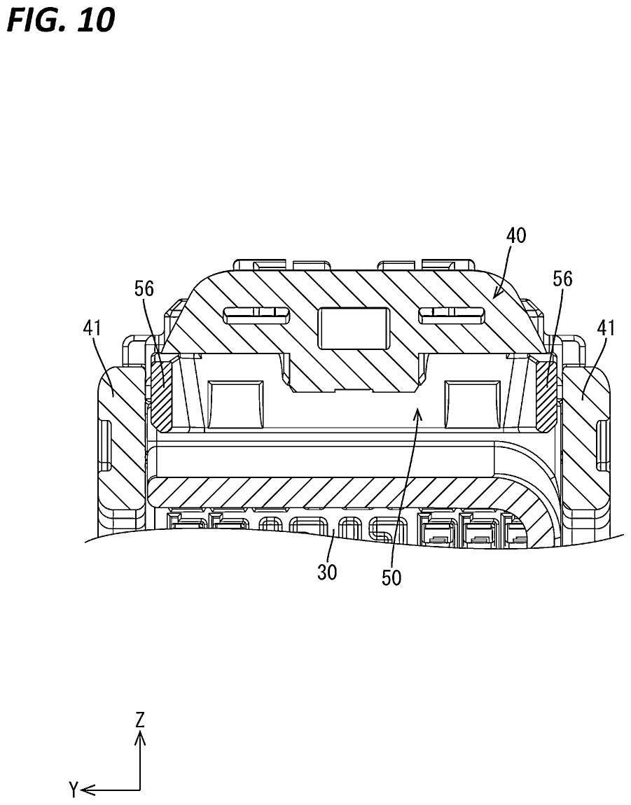

As shown in FIG. 10, the one or more protruding portions 56 particularly are proximate to the one or more plate-like portions 41 and/or disposed to substantially face the plate-like portions 41 in the lateral direction with the lever 40 located at the initial position and/or the detecting member located at the standby position.

In this way, if the plate-like portion 41 particularly is deformed in a direction toward the housing 30 along the lateral direction, the plate-like portion 41 particularly substantially comes into contact with the protruding portion 56 and/or the deformation of the plate-like portion 41 particularly is restricted.

In the particular embodiment, a part of the detecting member 50 is disposed adjacent to the plate-like portion(s) 41, particularly between the pair of plate-like portions 41, and/or the projecting portion 43 particularly at least partly is disposed in the recess 52 until the lever 40 is displaced (particularly rotated or pivoted) by a predetermined distance or angle from the initial position toward the completion position.

Here, the predetermined distance or angle particularly is not particularly limited in magnitude and may be such a distance or a rotation angle that the lever 40 is disposed between the initial position and the completion position.

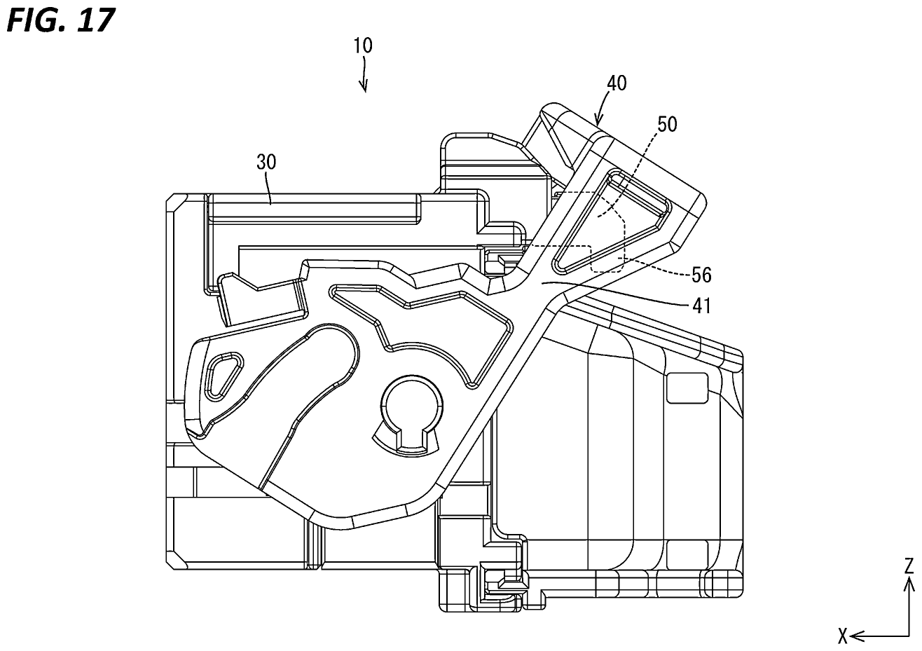

Specifically, FIG. 17 shows a state where the lever 40 is rotated by about 13°, which is smaller than a predetermined angle, from the initial position.

Here, the position of the lever 40 in FIG. 17 particularly is defined as a first position.

As shown in FIGS. 17 to 19, a part (in particular, a rear half) of the detecting member 50 including the protruding portion(s) 56 particularly is disposed between the plate-like portion(s) 41 with the lever 40 located at the first position.

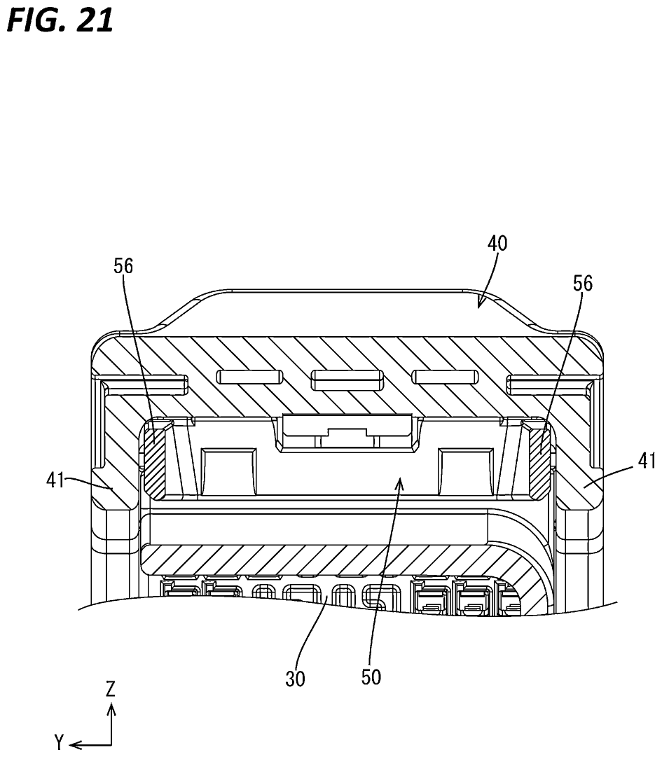

As shown in FIG. 21, the one or more protruding portions 56 particularly are proximate to the one or more plate-like portions 41 and/or disposed to substantially face the one or more plate-like portions 41 in the lateral direction.

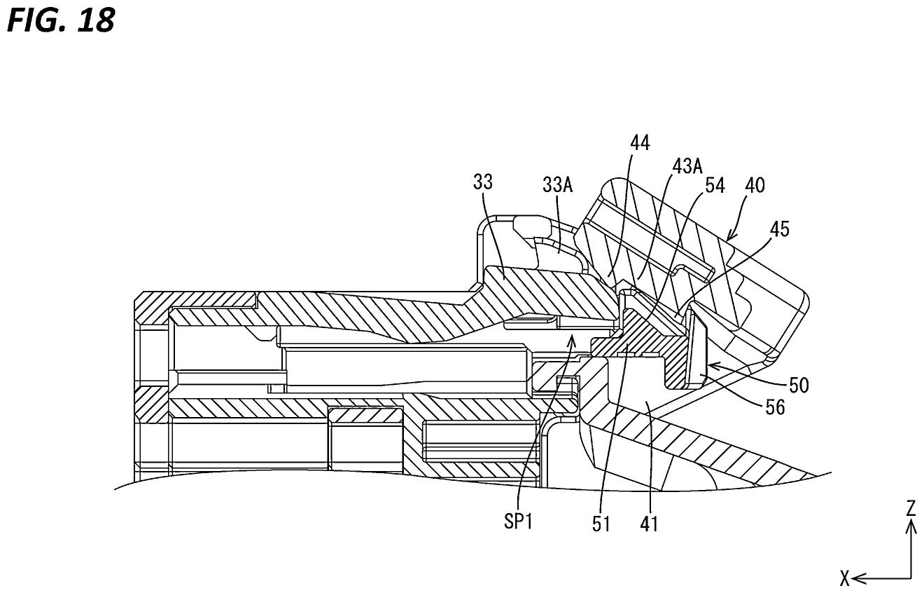

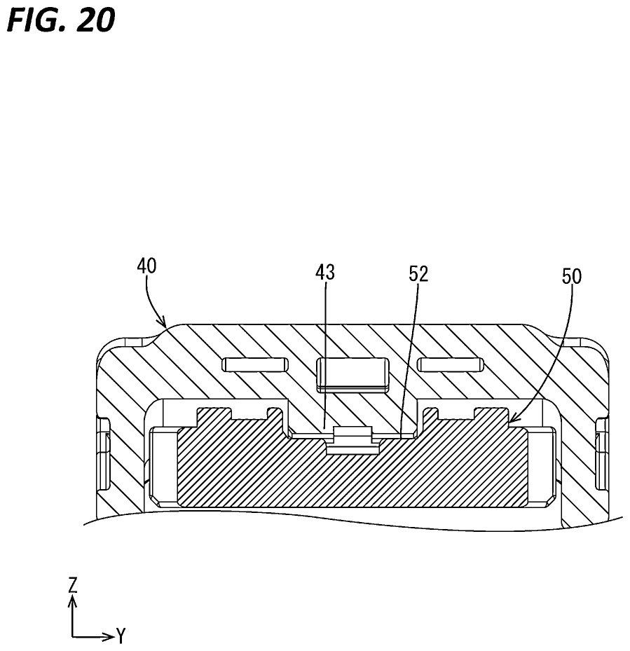

Further, as shown in FIG. 20, the projecting portion 43 particularly at least partly is disposed in the recess 52. In particular, as shown in FIG. 18, the base portion 43A at least partly is disposed in the second recess 54.

As shown in FIG. 19, the one or more lock portions 45 particularly are disposed in the first recesses 53.

As just described, in the embodiment, the part of the detecting member 50 particularly is disposed between the pair of plate-like portions 41 in a state where the lever 40 is at the initial position and a state until the lever 40 is displaced (particularly rotated) by the predetermined distance or angle from the initial position. Therefore, the breakage and movement of the detecting member 50 can be suppressed during a displacement or rotation operation of the lever 40. Thus, operability of the lever-type connector is improved.

Further, the projecting portion 43 particularly is disposed in the recess 52 in the state where the lever 40 is at the initial position and the state until the lever 40 is displaced (particularly rotated) by the predetermined distance or angle from the initial position. Therefore, the breakage and movement of the detecting member 50 can be suppressed and the lever 40 can be positioned in the lateral direction during the displacement (rotation) operation of the lever 40.

By particularly positioning the lever 40 in the lateral direction, the posture of the lever 40 can be stabilized and the displacement (particularly rotation or pivotal movement) of the lever 40 can be guided.

Furthermore, the one or more protruding portions 56 particularly are disposed to be able to contact the one or more plate-like portions 41 in the state where the lever 40 is at the initial position and/or a state until the lever 40 reaches at least the first position from the initial position.

In this way, the posture of the lever 40 during the displacement (rotation) operation particularly can be further stabilized and/or the deformation of the lever 40 can be suppressed.

When the lever 40 reaches the completion position, the rear half of the detecting member 50 particularly is disposed outside the pair of plate-like portions 41 and/or exposed to outside as shown in FIG. 12.

With the connection of the mating connector 20 and the lever-type connector 10 particularly completed, one or more releasing projections 21A provided in the receptacle 21 particularly contact the one or more locking projections 55A via the one or more openings 36 of the housing 30 as shown in FIG. 13.

In this way, the arm portions 55 particularly are deflected and/or deformed downward and the locking of the locking projection(s) 55A and the first locking portion(s) 35 is released.

If the detecting member 50 particularly is pushed forward here, the first locking portion(s) 35 and the inclined portion(s) 55B of the locking projection(s) 55A particularly substantially slide in contact and/or the locking projection(s) 55A sink below the first locking portion(s) 35.

The first locking portion(s) 35 particularly ride over the locking projection(s) 55A and/or the arm portion(s) 55 naturally return(s), whereby the detecting member 50 reaches the detection position (see FIG. 16).

With the detecting member 50 located at the detection position, the one or more locking projections 55A particularly at least partly are disposed in one or more window portions 21B provided in the receptacle 21.

The rear end surface(s) of the locking projection(s) 55A and the front end surface(s) of the first locking portion(s) 35 particularly are locked, thereby restricting a movement of the detecting member 50 from the detection position to the standby position.

As described above, the connection completion of the mating connector 20 and the lever-type connector 10 can be detected by a movement of the detecting member 50 toward or to the detection position.

In the embodiment, while the lever 40 is displaced (particularly rotated or pivoted) from the initial position toward the completion position, the base portion 43A, the pressing portion 44 and/or the lock portion(s) 45 particularly slide in contact with the lock arm 33 and/or the lock arm 33 particularly is deflected downward (see FIGS. 18 and 19). The lock arm 33 particularly is deflected and deformed and enters the first accommodation space SP1.

In this way, a rear end part of the lock arm 33 and the body portion 51 particularly substantially face each other in the front-rear direction.

With the lock arm 33 deflected and deformed in this way, the rear end part of the lock arm 33 and the body portion 51 particularly are locked, thereby restricting a forward movement of the detecting member 50 toward the detection position.

Thus, erroneous detection of the connection completion of the mating connector 20 and the lever-type connector 10 can be suppressed. Accordingly, operability of the lever-type connector is improved.

In this embodiment, the pressing portion 44 particularly first slides in contact with the rear end part of the lock arm 33 and/or the lock arm 33 particularly is deflected in the process of rotating the lever 40 from the initial position toward the completion position.

If the lever 40 is further displaced (particularly rotated or pivoted), the base portion 43A or the lock portion(s) 45 particularly start(s) to slide in contact with the upper surface(s) of the connection lock portion(s) 33A with the lock arm 33 deflected by the pressing portion 44 (see FIGS. 18 and 19).

If the lever 40 is further displaced (particularly rotated or pivoted), the base portion 43A or the lock portion(s) 45 particularly slide(s) in contact with the upper surface(s) of the connection lock portion(s) 33A and/or the pressing portion 44 and the lock arm 33 particularly no longer slide in contact with each other with the lock arm 33 deflected.

If the lever 40 is further displaced (particularly rotated or pivoted) and reaches the completion position, the lock portion(s) 45 and the upper surface(s) of the connection lock portion(s) 33A particularly no longer slide in contact with each other and/or the lock arm 33 particularly returns to a natural state as shown in FIG. 14.

If the lever 40 reaches the completion position, the lock portion(s) 45 and the connection lock portion(s) 33A particularly are disposed to be lockable in the front-rear direction.

By particularly locking the lock portion(s) 45 and the connection lock portion(s) 33A, the displacement (particularly rotation) of the lever 40 in a direction from the completion position toward the initial position is suppressed.

Further, the lock portion 33 particularly returns to the natural state, whereby the rear end part of the lock arm 33 and the body portion 51 no longer face each other in the front-rear direction.

Thus, the body portion 51 particularly can be at least partly accommodated into the first accommodation space SP1 by moving the detecting member 50 forward. That is, the detecting member 50 can be moved to the detection position.

As a result, proper connection of the mating connector 20 and the lever-type connector 10 particularly can be detected.

[Functions and Effects of Embodiment]

(1) The lever-type connector 10 according to the embodiment is provided with the housing 30, the lever 40 to be mounted on the housing 30 displaceably (particularly rotatably or pivotably) between the initial position and the completion position and the detecting member 50 to be mounted into the housing 30 movably between the standby position and the detection position. With the lever 40 located at the completion position, the detecting member 50 is movable from the standby position to the detection position. The lever 40 is provided with the pair of plate-like portions 41, the operating portion 42 coupling the pair of plate-like portions 41 in the first direction (lateral direction) and the projecting portion 43 projecting from the operating portion 42. The detecting member 50 is provided with the body portion 51 and the at least one recess 52 recessed from the body portion 51. With the lever 40 particularly located at the initial position and the detecting member 50 particularly located at the standby position, the detecting member 50 at least partly is disposed inside the pair of plate-like portions 41 in the first direction and/or the projecting portion 43 at east partly is disposed in the recess 52.

According to this configuration, since the detecting member 50 particularly at least partly is disposed inside the lever 40 with the lever 40 located at the initial position and the detecting member 50 located at the standby position, it is possible to suppress the damage of the detecting member 50 by an external force or the like, a movement of the detecting member 50 to the detection position, the detachment of the detecting member 50 from the housing 30 and the like.

Further, since the projecting portion 43 of the lever 40 particularly is disposed in the recess 52 of the detecting member 50, the lever 40 is easily positioned in the first direction by the detecting member 50.

Therefore, a deviation of the lever 40 in the first direction can be suppressed and the deformation and breakage of the lever 40 can be suppressed.

Thus, overall operability of the lever-type connector is improved.

(2) In the particular embodiment, the detecting member 50 particularly is disposed inside the pair of plate-like portions 41 in the first direction and the projecting portion 43 is disposed in the recess 52 until the lever 40 is displaced (particularly rotated or pivoted) by the predetermined distance (particularly by the predetermined angle) from the initial position toward the completion position.

According to this configuration, the detecting member 50 and the lever 40 particularly can be protected while the lever 40 is displaced by the predetermined distance, particularly rotated or pivoted by the predetermined angle, from the initial position.

Further, the projecting portion 43 and the recess 52 particularly are caused to slide in contact, whereby the rotation operation of the lever 40 can be guided.

(3) In the particular embodiment, the detecting member 50 particularly is provided with the one or more protruding portions 56 projecting (particularly toward both sides) in the first direction from the body portion 51, and movements of the plate-like portion(s) 41 in the direction(s) toward the housing 30 along the first direction are restricted by the contact of the protruding portion(s) 56 with the plate-like portion(s) 41.

According to this configuration, the deformation of the lever 40 in the first direction can be further suppressed.

Further, the displacement or rotation operation of the lever 40 can be guided.

(4) In the embodiment, the housing 30 particularly is provided with the deflectable and deformable lock arm 33 extending from the outer surface (upper surface) of the housing 30, the projecting portion 43 particularly includes a slide-contact portion (particularly base portion 43A, pressing portion 44 and/or lock portions 45) for deflecting the lock arm 33 by sliding in contact with the lock arm 33 in the process of displacing (particularly rotating or pivoting) the lever 40 from the initial position toward the completion position, and/or the lock arm 33 particularly slides in contact with the slide-contact portion, whereby the lock arm 33 is locked to the detecting member 50 and/or a movement of the detecting member 50 from the standby position to the detection position is restricted.

According to this configuration, since a movement of the detecting member 50 to the detection position is restricted during the displacement (rotation) operation of the lever 40 by the slide-contact portion, erroneous detection of the connection completion is suppressed by the detecting member 50.

Further, since the projecting portion 43 particularly includes the slide-contact portion, a slide-contact portion may not be provided at a position different from the projecting portion 43 in the lever. Thus, the lever 40 and the lever-type connector 10 are easily reduced in size.

(5) In the embodiment, the projecting portion 43 particularly includes the one or more lock portions 45 to be locked to the housing 30 with the lever 40 located at the completion position.

According to this configuration, since the projecting portion 43 includes the lock portion(s) 45, a lock portion may not be provided at a position different from the projecting portion 43 in the lever 40. Thus, the lever 40 and the lever-type connector 10 are easily reduced in size.

Accordingly, to provide a lever-type connector capable of protecting a detecting member and a lever, a lever-type connector 10 is provided with a housing 30, a lever 40 to be mounted on the housing 30 displaceably (particularly rotatably or pivotably) between an initial position and a completion position, and a detecting member 50 to be mounted into or to the housing 30 movably between a standby position and a detection position. The detecting member 50 is movable from the standby position to the detection position with the lever 40 located at the completion position.

The lever 40 particularly includes a pair of plate-like portions 41, an operating portion 42 coupling the pair of plate-like portions 41 in a first direction and a projecting portion 43 projecting from the operating portion 42.

The detecting member 50 particularly includes a body portion 51 and a recess 52 recessed from the body portion 51. The detecting member 50 is disposed inside the pair of plate-like portions 41 in the first direction and the projecting portion 43 at least partly is disposed in the recess 52 with the lever 40 located at the initial position and the detecting member 50 located at the standby position.

### OTHER EMBODIMENTS

The above embodiment can be modified and carried out as follows. The above embodiment and the following modifications can be carried out in combination without technically contradicting each other.
Although the projecting portion 43 particularly includes the pressing portion 44 and the one or more lock portions 45 in the above embodiment, a projecting portion may project from an operating portion and/or the shape thereof may be different from the above one.
Although the recess 52 particularly includes the one o more first recesses 53 and the at least one second recess 54 in the above embodiment, a recess may be recessed from a body portion and configured such that a projecting portion can at least partly enter the recess, and/or the shape thereof may be different from the above one.
Although the detecting member 50 particularly includes the one or more protruding portions 56 in the above embodiment, a detecting member may include no protruding portion.
Although the lever-type connector 10 particularly is provided with the wire cover 32 in the above embodiment, a lever-type connector may not be provided with a wire cover.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A lever-type connector (10), comprising:
a housing (30);
a lever (40) to be mounted on the housing (30) displaceably between an initial position and a completion position; and
a detecting member (50) to be mounted into the housing (30) movably between a standby position and a detection position,
the detecting member (50) being movable from the standby position to the detection position with the lever (40) located at the completion position,
the lever (40) including a pair of plate-like portions (41), an operating portion (42) coupling the pair of plate-like portions (41) in a first direction and a projecting portion (43) projecting from the operating portion (42),
the detecting member (50) including a body portion (51) and at least one recess (52) recessed from the body portion (51), and
the detecting member (50) at least partly being disposed inside the pair of plate-like portions (41) in the first direction and the projecting portion (43) at least partly being disposed in the recess (52) with the lever (40) located at the initial position and the detecting member (50) located at the standby position.

2. The lever-type connector according to claim 1, wherein the detecting member (50) at least partly is disposed inside the pair of plate-like portions (41) in the first direction and the projecting portion (43) at least partly is disposed in the recess (52) until the lever (40) is displaced by a predetermined distance from the initial position toward the completion position.

3. The lever-type connector according to claim 1, wherein:
the detecting member (50) includes one or more protruding portions (56) projecting in the first direction from the body portion (51), preferably toward both sides in the first direction from the body portion (51), and
the one or more protruding portions (56) contact the one or more plate-like portions (41), thereby restricting movements of the plate-like portions (41) in directions toward the housing (30) along the first direction.

4. The lever-type connector according to claim 1, wherein:
the housing (30) includes at least one deflectable and deformable lock arm (33) extending from an outer surface of the housing (30), and
the projecting portion (43) includes at least one slide-contact portion (43A; 44; 45) for deflecting the lock arm (33) by sliding in contact with the lock arm (33) in the process of displacing the lever (40) from the initial position toward the completion position.

5. The lever-type connector according to claim 4, wherein the lock arm (33) substantially slides in contact with the slide-contact portion (43A; 44; 45), whereby the lock arm (33) is locked to the detecting member (50) and/or a movement of the detecting member (50) from the standby position to the detection position is restricted.

6. The lever-type connector according to claim 1, wherein the projecting portion (43) includes at least one lock portion (45) to be locked to the housing (30) with the lever (40) located at the completion position.
